(19) United States
(12) Patent Application Publication
(10) Pub. No.: US 2013/0332461 A1
(43) Pub. Date: Dec. 12, 2013

(54) COMPUTER-BASED CONFIDENTIAL DISCLOSURE SEARCH TOOL

(71) Applicants: James T. Shea, Lyme, NH (US); Samuel C. Baxter, Brewster, MA (US); Natalia V. Britvikhina, West Henrietta, NY (US); John E. Meczynski, JR., Tonawanda, NY (US)

(72) Inventors: James T. Shea, Lyme, NH (US); Samuel C. Baxter, Brewster, MA (US); Natalia V. Britvikhina, West Henrietta, NY (US); John E. Meczynski, JR., Tonawanda, NY (US)

(73) Assignee: IP.COM I, LLC, Fairport, NY (US)

(21) Appl. No.: 13/491,875

(22) Filed: Jun. 8, 2012

(51) Int. Cl. G06F 17/30

(52) U.S. Cl. 707/741; 707/758; 707/749; 707/E17.008; 707/E17.069

(57) ABSTRACT

A computer-based apparatus for searching confidential documents, including a computer with a memory element and a processor to execute instructions stored in the memory to receive a confidential document and related non-confidential information from a source entity. The processor executes the instructions to: store the confidential document and non-confidential information in the memory element; and restrict access to the confidential document stored in the memory element to the source entity and a library entity only, or to the first source entity only. The processor executes the computer readable instructions to: receive a search request from a searching entity including a search parameter; identify the search parameter as being applicable to the confidential document; and transmit for access by the searching entity, the non-confidential information. The library entity is different from the source entity.

### TECHNICAL FIELD

The present disclosure relates to an apparatus and method for searching confidential documents, in particular, searching confidential documents not accessible by the searcher to provide non-confidential information related to applicable confidential documents.

### BACKGROUND

Entities such as an individual, an organization, an academic institution, or a business must keep certain documents related to invention disclosures, product development, technical topics, and research confidential, for example, in order to preserve intellectual property rights or business/marketing positions. Such entities could benefit from licensing, royalty, or mutual research agreements related to the content of these documents; however, the need to maintain the confidentiality of these documents works contrary to pursuing and obtaining such agreements. For example, other entities that may be suitable candidates may have no knowledge of the documents or means of obtaining such knowledge due to the confidentiality of the documents.

Abstracted summaries (non-confidential information) for confidential documents may be available; however, such summaries do not provide enough information for a successful search. That is, searching the abstracts does not correlate well to searching the actual confidential documents. The entities associated with the confidential documents can attempt to identify and contact candidate entities for agreements; however, this is a very time consuming and expensive process and may entirely miss promising candidates. Likewise, candidate entities can attempt to identify and contact entities that may have confidential documents that may be of interest; however, this also is a very time consuming and expensive process and may entirely miss entities that may have relevant confidential documents. For example, a large percentage of Confidential Disclosure Agreements (CDAs) currently executed with universities result in no further action, because the CDAs are executed with so little knowledge of the actual confidential information. Even if entities with confidential documents and candidate entities can be identified, there is no automatic process for mining applicable data and obtaining metadata or other useful information.

The inability to access confidential documents or to conduct searches that accurately portray the content of confidential documents generally hinders technical and business related research and development, which in turn hampers economic growth.

### SUMMARY

According to aspects illustrated herein, there is provided a computer-based method for searching confidential documents, including: storing, in at least one memory element of at least one computer, computer readable instructions; and executing, using at least one processor for the at least one computer, the computer readable instructions to receive from a first source entity a first confidential document and first non-confidential information for the first confidential document. The method includes executing, using at least one processor, the computer readable instructions to: store the first confidential document and the first non-confidential information in the at least one memory element; and limit access to the first confidential document stored in the at least one memory element to the first source entity and a library entity only, or the first source entity only. The method includes executing, using at least one processor, the computer readable instructions to: receive a search request from a searching entity including a first search parameter; identify the first search parameter as being applicable to the first confidential document; and transmit for access by the searching entity, the first non-confidential information. The library entity is different from the first source entity and has sole control over access to the at least one memory element.

According to aspects illustrated herein, there is provided a computer-based apparatus for searching confidential documents, including at least one memory element of at least one computer configured to store computer readable instructions and at least one processor for the at least one computer configured to execute the computer readable instructions to receive from a first source entity a first confidential document and first non-confidential information for the first confidential document. The processor is configured to execute the computer readable instructions to: store the first confidential document and the first non-confidential information in the at least one memory element; and limit access to the first confidential document stored in the at least one memory element to the first source entity and a library entity only, or the first source entity only. The processor is configured to execute the computer readable instructions to: receive a search request from a searching entity including a first search parameter; identify the first search parameter as being applicable to the first confidential document; and transmit for access by the searching entity, the first non-confidential information. The library entity is different from the first source entity and has sole control over access to the at least one memory element.

According to aspects illustrated herein, there is provided a computer-based method for searching confidential documents, including storing, in at least one memory element of at least one computer, computer readable instructions and executing, using at least one processor for the at least one computer, the computer readable instructions to receive from first and second source entities first and second confidential documents, respectively, and first and second non-confidential information for the first and second confidential documents, respectively. The method includes executing, using at least one processor, the computer readable instructions to: store the first and second confidential documents and the first and second non-confidential information in the at least one memory element; limit access to the first confidential document stored in the at least one memory element to the first source entity and a library entity only, the library entity different from the first source entity; limit access to the second confidential document stored in the at least one memory element to the second source entity and the library entity only; perform keyword and semantic analysis of the first and second confidential documents to create at least one first index parameter related to content of the first and second confidential documents; store the at least one first index parameter in an index; delete the first and second confidential documents from the at least one memory element; receive a search request from a searching entity including a first search parameter; identify the first search parameter as being applicable to the first and second confidential documents by searching the index to match the first search parameter with the at least one index parameter; rank the first and second confidential documents, according to relevance with respect to the first search parameter, in a first order; and transmit for access by the searching entity, the first and second non-confidential information ranked in the first order. The library entity has sole control over access to the at least one memory element.

According to aspects illustrated herein, there is provided a computer-based apparatus for searching confidential documents, including at least one memory element of at least one computer configured to store computer readable instructions and at least one processor for the at least one computer configured to execute the computer readable instructions to receive from first and second source entities first and second confidential documents, respectively, and first and second non-confidential information for the first and second confidential documents, respectively. The processor is configured to execute the computer readable instructions to: store the first and second confidential documents and the first and second non-confidential information in the at least one memory element; limit access to the first confidential document stored in the at least one memory element to the first source entity only; limit access to the second confidential document stored in the at least one memory element to the second source entity only; perform keyword and semantic analysis of the first and second confidential documents to create at least one first index parameter related to content of the first and second confidential documents; store the at least one first index parameter in an index; receive a search request from a searching entity including a first search parameter; identify the first search parameter as being applicable to the first and second confidential documents by searching the index to match the first search parameter with the at least one index parameter; rank the first and second confidential documents, according to relevance with respect to the first search parameter, in a first order; and transmit for access by the searching entity, the first and second non-confidential information ranked in the first order. The library entity has sole control over access to the at least one memory element.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic block diagram of an apparatus for searching confidential documents; and,

FIGS. 2-5 are pictures of screen shots illustrating operation of an apparatus for searching confidential documents.

### DETAILED DESCRIPTION

Moreover, although any methods, devices or materials similar or equivalent to those described herein can be used in the practice or testing of these embodiments, some embodiments of methods, devices, and materials are now described.

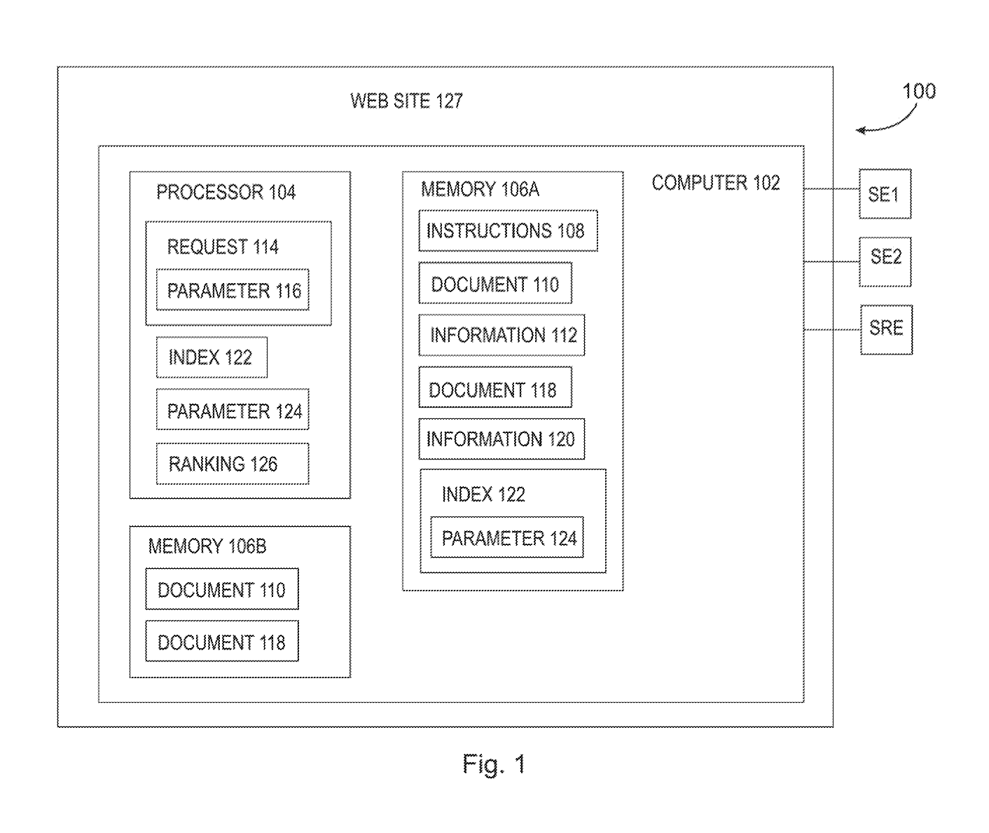

FIG. 1 is a schematic block diagram of computer-based apparatus 100 for searching confidential documents. Apparatus 100 includes at least one computer 102 with at least one processor 104 and at least one memory element 106. The memory element is configured to store computer readable instructions 108. The processor is configured to execute the computer readable instructions to receive, from source entity SE1, confidential document 110 and non-confidential information 112 for the confidential document; and to store document 110 and non-confidential information 112 in the at least one memory element. The processor is configured to execute the computer readable instructions to restrict, or limit, access to non-confidential information 112 to SE1 and library entity LE only, or to SE1 only. Stated otherwise, the processor blocks access to the confidential document to all entities except, or but, SE1 and LE, or to all entities except, or but, SE1. LE is different from SE1, that is LE and SE1 are separate and distinct entites. By limit or restrict access, to SE1 and/or LE we mean that the only entities that are able to gain legal or authorized access to the confidential document are SE1, or SE1 and LE. Any means known in the art can be used to enforce the limit, restrict, and block access to confidential documents. In general, non-confidential information in the context of apparatus 100 provides information about a respective confidential document without revealing confidential information in the document.

By “confidential document” we mean a document access to which is controlled solely by the source entity. In general, the source entity wishes to block access to the confidential document by all outside, or other, entities that have not signed a Confidential Disclosure Agreement, related to the information in the confidential document, with the source entity. By “non-confidential information” we mean information that provides some insight into the content of a related confidential document without revealing those aspects of the confidential document to which the source entity wishes to block access. As described below, non-confidential information can include meta-data. By “meta-data” we mean data about data or data supplementing data.

Computer 102 can be any computer or plurality of computers known in the art. In one embodiment, the computer is located in a single location. In one embodiment, multiple computers 102 are located in different locations and are linked by any means known in the art. Processor 104 can be any processor known in the art. Memory element 106 can be any memory element known in the art. In an example embodiment, the memory element is separate from computer 102 and is linked to computer 102 by any means known in the art.

By library entity LE we mean the entity operating and controlling apparatus 100. A key aspect of apparatus 100 is that the library entity has sole control over access to computer 102, in particular, memory element 106 and the confidential documents stored in computer 102, for example in element 106. For example, the library entity operates and controls the software, firmware, and hardware for apparatus 100 through which other entities, such as search entities, interface with apparatus 100. In one embodiment, the library entity cannot access confidential documents stored in apparatus 100, but still controls access to confidential documents stored in apparatus 100. Thus, document 110 is held in strict confidence and any confidential status of document 110 is preserved by apparatus 100 and the library entity.

A source entity can be any individual, business entity, academic entity, organizational entity, governmental entity, or individual associated with a business, academic, organizational, or governmental entity known in the art.

Document 110 can be any document known in the art, including, but not limited to, an invention disclosure, a technical paper, a research paper, a draft patent application, an unpublished patent application, or a white paper, and can be in any format known in the art.

The processor is configured to execute the computer readable instructions to receive search request 114, from searching entity SRE, including search parameter 116, and to identify the search parameter as being applicable to confidential document 110. The processor is configured to execute the computer readable instructions to transmit for access by SRE, non-confidential information 112. Thus, SRE is able to conduct a search of confidential document 110 while confidential document 110 remains confidential (SRE cannot access document 110) and receive non-confidential information 112 pertinent to confidential document 110. In an example embodiment, non-confidential information 112 transmitted to SRE is in the form of a publically accessible display. That is, access to non-confidential information 112 is not generally restricted. Thus, apparatus 100 enables a previously unknown and undoable search of confidential information by entities not privy to the confidential information itself. A searching entity can be any individual, business entity, academic entity, organizational entity, governmental entity, or individual associated with a business, academic, organizational, or governmental entity known in the art.

It should be understood that a searching entity also can be a source entity. For example, a university may have a plurality of confidential documents stored in the memory element and may also conduct a search of those documents using apparatus 100. Thus, a source entity can mine its own confidential documents.

The processor is configured to execute the computer readable instructions to receive any number of confidential documents and respective non-confidential information from any number of source entities. For example, the processor is configured to execute the computer readable instructions to receive and store confidential document 118 and non-confidential information 120 for confidential document 118 from source entity SE2, different from SE1, in a manner similar to that described for confidential document 110 and non-confidential information 112. The processor is configured to execute the computer readable instructions to limit access to confidential document 118 to SE2 and LE only, or to SE2 only.

As described above for confidential document 110, in response to receipt of a search parameter, non-confidential information 120 can be sent out. For example, in response to receipt of search parameter 116, the processor determines if the search parameter is applicable to confidential document 118, and if so, transmits non-confidential information 120 for access by SRE. It should be understood that apparatus 100 is not limited to a particular number of source entities, a particular number of confidential documents, or a particular type, amount, or number of non-confidential information.

In an example embodiment, apparatus 100 is arranged create index 122 for confidential documents stored in the memory unit. For example, the processor executes the computer readable instructions to perform keyword or semantic analysis to create at least one index parameter 124 related to the content of confidential document 110, and the processor stores parameter 124 in the index. The processor then correlates the index parameter with the appropriate confidential and/or non-confidential document. In an example embodiment, the index is stored in memory element 106 and access to the index is controlled by the library entity.

In an example embodiment, to identify search parameter 116 as being applicable to confidential document 110, the processor searches the index, without accessing document 110 itself. For example, the processor determines that parameter 116 is applicable to parameter 124 and through the correlation of index parameters to non-confidential documents, selects information 112. The searching of the index rather than the confidential documents creates an additional layer of confidentiality. For example, confidential documents could be stored in a memory element 106B, separate from memory element 106A used to store the index. Then, operation of apparatus 100 to identify applicable confidential documents, such as evaluating search parameters etc. is restricted to memory element 106A, reducing the likelihood of unauthorized access to the confidential documents in memory 106B. Apparatus 100 is not limited to any particular number of index parameters.

In an example embodiment, once a confidential document has been indexed, the confidential document is deleted from memory 106. That is, the confidential document is not stored in apparatus 100, further enhancing confidentiality of the confidential document.

In an example embodiment, once parameter 124 has been created, and a search of confidential documents in apparatus 100 has been performed using index 122 with parameter 124, the confidential document is deleted from memory 106 and parameter 124 is deleted from index 122. That is, neither the confidential document nor information in the index regarding the confidential document is stored in apparatus 100. For example, an entity may wish to conduct a search of confidential documents stored by apparatus 100 with respect to a confidential document provided by the entity (in this case, the entity in question functions as both a source and a search entity). However, the entity does not wish to leave a trace of this search in apparatus 100. Therefore, once the confidential document is indexed to enable the search of other confidential documents in apparatus and results are returned to the entity in question, the index is operated upon as noted above to remove parameter 124 associated with the confidential document.

It should be understood that the indexing and storage operations described above are applicable to any number of confidential documents and any number of source entities.

In an example embodiment, apparatus 100 provides ranking 126 of non-confidential information provided to a searcher. Thus, although specific confidential information cannot be provided to a searcher, an indication of the relative relevance of confidential documents can be provided. Non-confidential information for a plurality of respective confidential documents may not accurately represent the actual relevance of the confidential documents. For example, confidential document 110 may be more relevant to a search parameter than confidential document 118; however, non-confidential information 120 may appear to be more relevant than non-confidential information 112. In this case, the processor would recognize the relevance of the confidential documents, rank the confidential documents accordingly, and present respective non-confidential documents according to the ranking of the confidential documents.

Thus, a searcher is guided to the most applicable confidential documents despite the fact that the searcher never accesses or views the confidential documents in question and the non-confidential information itself may not best represent the applicability of the confidential documents. The ranking process described above can be performed on multiple confidential documents from a single source entity or on any combination of confidential documents from any combination of source entities.

In an example embodiment, confidential documents are received using an appropriate transmission methodology, for example, using a secured protocol or medium, and the processor is configured to execute the computer readable instructions to encrypt and store the confidential documents.

Non-confidential information can include, but is not limited to, an abstract (summary) of a confidential document or metadata for the confidential document, including, but not limited to, an author or authors, title, language, copyright, country of origin, an organization associated with the confidential document, and contact information for the author(s) or the organization.

Source and search entities can access apparatus 100 using any means known in the art. In an example embodiment, apparatus 100 is interfaced with Internet web site 127 and source and search entities are able to access apparatus 100 via the Internet.

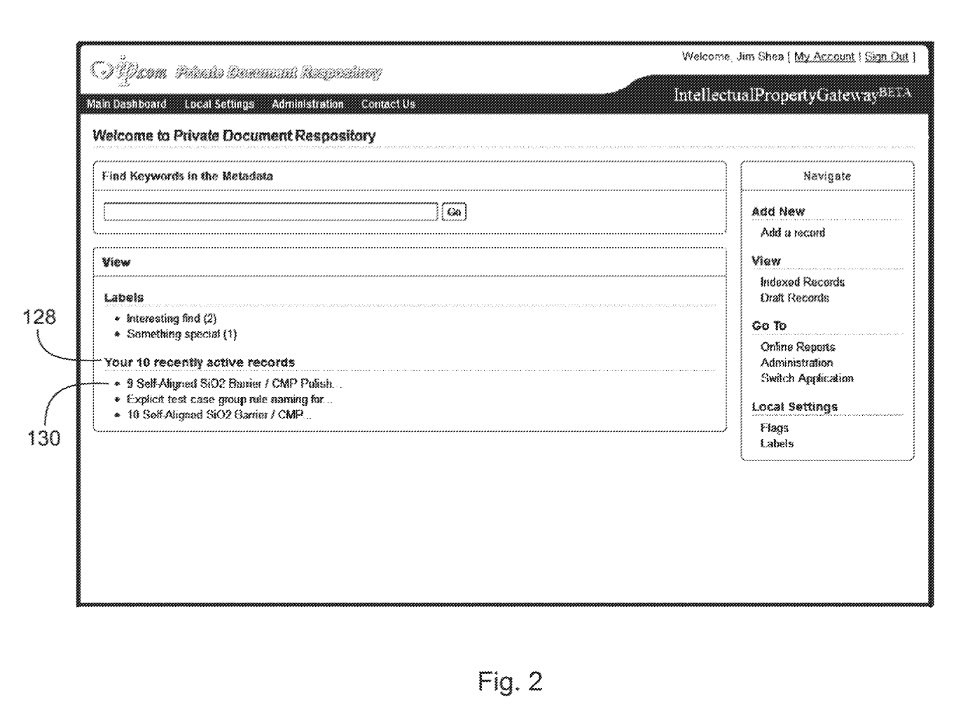

FIGS. 2-5 are pictures of screen shots illustrating operation of an apparatus for searching confidential documents. The following should be viewed in light of FIGS. 1 through 5. To generate the picture of FIG. 2, a search entity has accessed apparatus 100 via website 127 and has logged into their account. The user selected the portal “Private Library Portal,” which in this example includes the operations described above as being executable by a search entity. The opening page for the portal is shown in FIG. 2. From this page, the user can upload confidential and non-confidential documents to apparatus 100, perform searches of documents using apparatus 100, or generate reports. Listing 128 is a listing of recently accessed confidential documents associated with the user. For example, the user could be SE1 and the documents in listing 128 are documents provided to apparatus 100 by SE1.

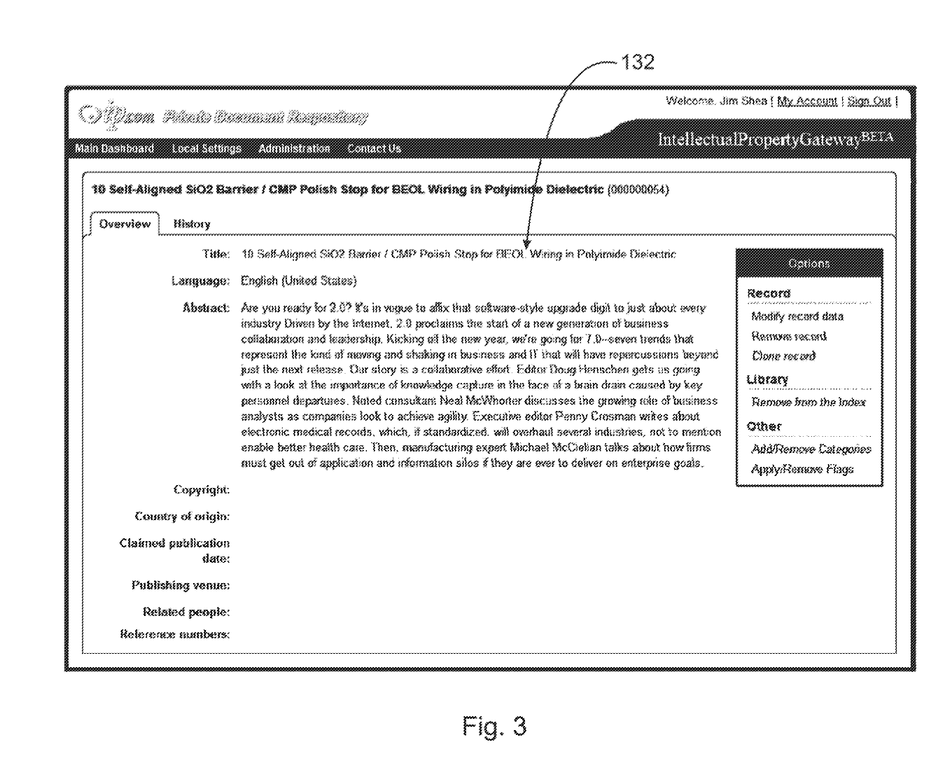

The user selected document 130 from listing 128 to generate the picture in FIG. 3. Metadata 132 for document 130 is displayed in FIG. 3. From this page, the user can review the metadata, edit the metadata, or add to the metadata.

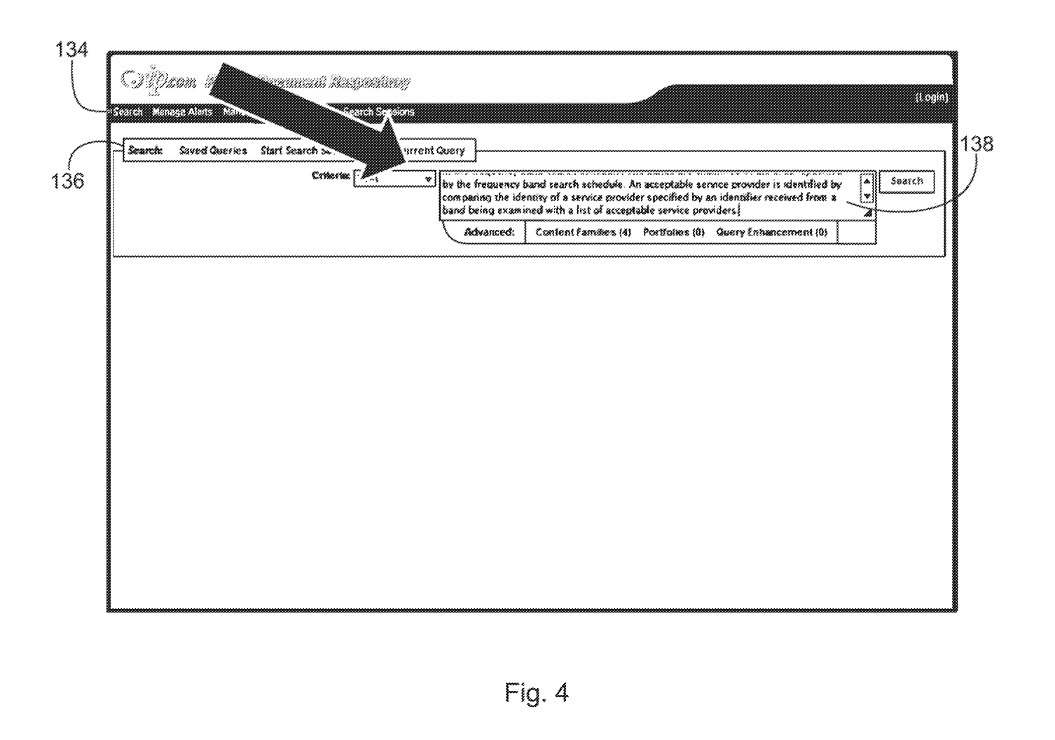

To generate the picture in FIG. 4, a search entity has accessed website 127, selected search options 134 and option 136. The user then provided search parameters in field 138. The search parameters can be text added by the user or a document for which the user is seeking similar documents.

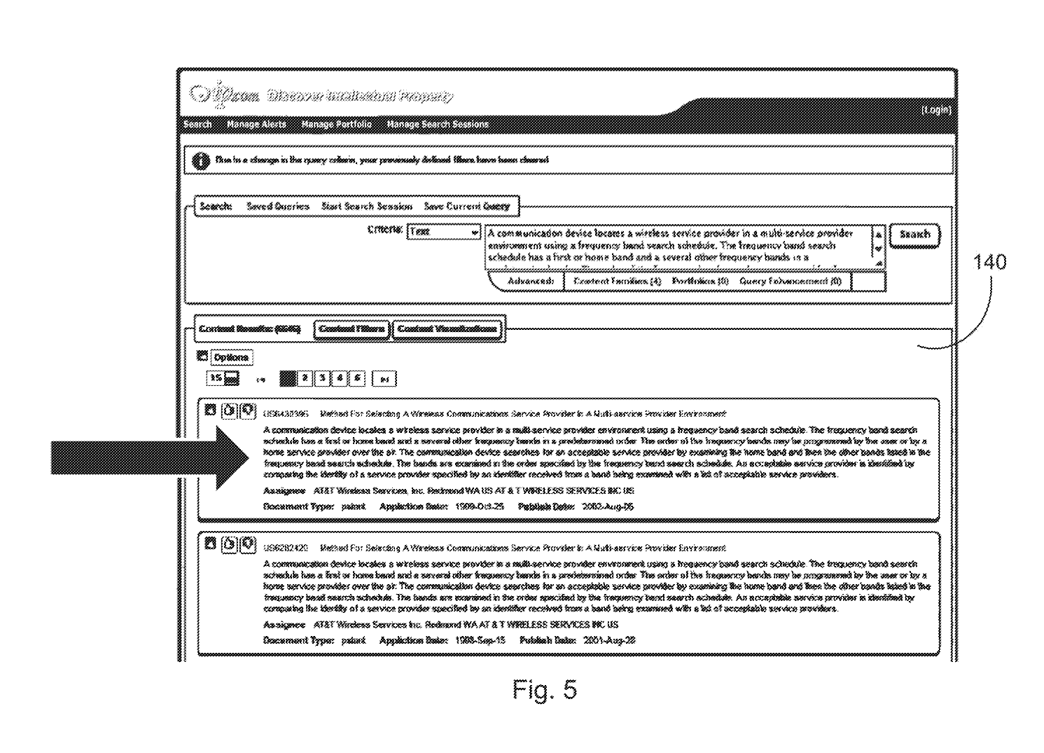

The results of the search initiated in FIG. 4 are shown in field 152 in FIG. 5. In this case, abstracts and metadata are returned as the non-confidential documents. The metadata includes assignee information, document type, and document information. No confidential information has been displayed.

Apparatus 100 enables source entities to make confidential documents, such as confidential technology disclosures, searchable in memory element 106, while maintaining the confidentiality of the documents. Advantageously, apparatus 100 enables source entities with confidential information and entities interested in engaging in some type of agreement with the source entities regarding the confidential information to find accurate matches. For example, Confidential Disclosure Agreements (CDAs) can be executed with a much greater confidence that confidential documents identified by a search through apparatus 100 are applicable to a searcher's needs and desires, which advantageously results in further action and reduces time and resources wasted in fruitless CDAs.

In one embodiment, apparatus 100 issues a CDA to a search entity for one or more confidential documents in memory 106 identified by a search through apparatus 100 to automate and facilitate the CDA process. In one embodiment, a confidential document takes the form of a “research needs confidential disclosure,” which creates an opportunity for corporations to develop and define their research needs. For example, the confidential disclosure includes the details of a product or process being developed (to ensure that searches are accurate), while an abstract provides the associated non-confidential document. Thus, parties that would be useful collaborators or consumers and that would otherwise have no means knowing of the existence of the product or process can be matched to the corporations.

Apparatus 100 can be used to identify licensing leads related to confidential documents. For example, university licensing officers can use apparatus 100 to search for patents related to their confidential disclosures to identify leads that could include corporate research laboratories or business units with which the university has not previously worked. This aspect of apparatus 100 replaces the hit-or-miss process described above.

Apparatus 100 can be used to identify research partner leads. For example, university faculty writing new research proposals to government agencies could automatically search to identify research partners, a process which is currently not possible. Federal agencies are demanding more and more collaborative research and State agencies often require in-state universities to work with in-state companies. Apparatus 100 can facilitate these processes.

Apparatus 100 can be used to identify investor leads. Start-ups and venture organizations could search for organizations with promising non-confidential information to target for capital, sales and/or partnering.

The impact and results of grants can be tracked through apparatus 100. Often, documents or information related to such impacts or results are confidential, for example, as patent applications or research documents. However, by properly identifying search terms applicable to the grant, confidential information such as patent applications and research documents can be identified, a process which enables granting agencies to assess the success of various grants and to adjust granting strategies to target specific areas or to increase economic impact of the grants.

Apparatus 100 can be used by business entities to identifying new technologies and potential research partners, for example technologies that may be synergistic or technologies that the entity may wish to purchase to head off possible competition. For example, a corporation could identify an abstract at a university website; determine appropriate search parameters, and using apparatus 100, search memory 106. The results of the search could them be compared directly with specific research, development, or marketing needs for the corporation. Thus, with a single search through apparatus 100, the corporation can access a wide range of technologies and disclosures without the need to search one company, agency, or academic institution at a time.

Increasingly, business entities are seeking out external research partners because of the potential cost savings. A business entity can generate a “research needs listings” and use the listing as the basis for developing search parameters. The business entity can conduct a search using apparatus 100 and the search parameters to identify matches, for example, with corporate research facilities or universities. For example, the business entity could allow access to their confidential and non-confidential documents in memory 106 to other business entities and/or universities seeking financial or research partners. For example, university faculty may disclose in a confidential document a process that is unknown to the business entity, but which may be valuable to the business entity.

Business or academic entities can use apparatus 100 and their own confidential disclosures or non-confidential documents found in a search of memory 106 as search tools against journal content, to identify additional researchers publishing in a particular area. Corporations could upload pre-published patent applications into apparatus 100 for their own use (such as use as a search tool for competitive intelligence) or simply as the confidential document for a non-confidential document.

Apparatus 100 can be used for subscriptions and alerts. Business and academic entities can establish alert systems that use apparatus 100 to execute periodic searches of relevant new content in memory 106. These could be delivered on a subscription basis or as alerts when relevant documents are identified. Federal and State agencies can build subscriptions relevant to their specific areas of concern. State business development agencies could track the emergence of new technologies within fields that they fund, and at academic institutions. State business development agencies could limit searches to business and academic entities in their own state to facilitate growth in the state and could use apparatus 100 to identify areas for potential investment. Similarly, apparatus 100 can be used to identify gaps in university research personnel for emerging economic sectors, as a way to encourage universities to build strength in targeted research needs.

Apparatus 100 can be used by academic research offices to better understand opportunities to link cross-institutional strengths within their own institution, and map those strengths against emerging areas of science and technology. For example, faculty working in complementary areas of bioengineering might be scattered across a campus within Engineering, Biology, Biophysics, and other departments; the same could be true for more senior faculty who have decided to transition their research mid-career into a new, more interesting area. Searching the confidential disclosures, especially against journal articles and other material in the database, could enable offices to map their internal research capabilities to better pursue external funding and external partnerships.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A computer-based method for searching confidential documents, comprising:
storing, in at least one memory element of at least one computer, computer readable instructions; and,
executing, using at least one processor for the at least one computer, the computer readable instructions to:
receive from a first source entity:
a first confidential document; and,
first non-confidential information for the first confidential document;
store the first confidential document and the first non-confidential information in the at least one memory element;
restrict access to the first confidential document stored in the at least one memory element to:
the first source entity and a library entity only; or,
the first source entity only;
receive a search request, from a searching entity, including a first search parameter;
identify the first search parameter as being applicable to the first confidential document; and,
transmit for access by the searching entity, the first non-confidential information, wherein the first non-confidential information includes contact information for the author or the organization.

2. The computer-based method of claim 1, wherein transmitting, for access by the searching entity, the first non-confidential information includes transmitting the first non-confidential information for publically accessible display.

3. The computer-based method of claim 1, further comprising executing, using the at least one processor, the computer readable instructions to:
receive a second confidential document from a second source entity, different from the library entity;
receive second non-confidential information for the second confidential document from the second source entity; and,
limit access to the second confidential document stored in the at least one memory element to:
the second source entity and the library entity only; or,
the second source entity only.

4. The computer-based method of claim 1, further comprising, executing, using the processor, the computer readable instructions to:
perform keyword or semantic analysis to create at least one index parameter related to content of the first confidential document; and,
store the at least one index parameter in an index, wherein identifying the first search parameter as being applicable to the first confidential document includes searching the index to match the first search parameter with the at least one index parameter.

5. The computer-based method of claim 4, further comprising, executing, using the processor, the computer readable instructions to:
delete the first confidential document from the at least one memory element; or,
delete the first confidential document from the at least one memory element and the at least one index parameter from the index.

6. The computer-based method of claim 1, further comprising, executing, using the processor, the computer readable instructions to:
receive from a second source entity, different from the library entity:
a second confidential document; and,
second non-confidential information regarding the second confidential document;
store the second confidential document and the second non-confidential information in the in at least one memory element;
limit access to the second confidential document stored in the at least one memory element to:
the second source entity the library entity only; or,
the second source entity only;
perform keyword or semantic analysis of the first and second confidential documents to create at least one first index parameter related to content of the first and second confidential documents;
store the at least one first index parameter in an index;
identify the first search parameter as being applicable to the second confidential document by searching the index to match the first search parameter with the at least one index parameter; and,
transmit for access by the searching entity, the second non-confidential information, wherein identifying the first search parameter as being applicable to the first confidential document includes searching the index to match the first search parameter with the at least one index parameter.

7. The computer-based method of claim 1, further comprising executing, using the processor, the computer readable instructions to:
receive, from the first source entity, a plurality of first confidential documents and a plurality of respective first non-confidential information for the plurality of first confidential documents;
store the plurality of first confidential documents and the plurality of respective first non-confidential information in the at least one memory element;
limit access to the plurality of first confidential documents stored in the at least one memory element to:
the first source entity and the library entity only; or,
the first source entity only;
in response to receiving the search request, rank, in a first order, the plurality of first confidential documents according to relevance with respect to the first search parameter; and,
transmit for access by the searching entity, the plurality of respective first non-confidential information ranked in the first order.

8. The computer-based method of claim 1, further comprising, executing, using the processor, the computer readable instructions to:
receive from a second source entity, different from the library entity:
a second confidential document; and,
second non-confidential information regarding the second confidential document;
store the second confidential document and the second non-confidential information in the in at least one memory element;
limit access to the second confidential document stored in the at least one memory element to:
the second source entity and the library entity only; or,
the second source entity only;
in response to receiving the search request, ranking, in a first order, the first and second confidential documents according to relevance with respect to the first search parameter; and,
transmit for access by the searching entity, the first and second non-confidential information ranked in the first order.

9. The computer-based method of claim 1, wherein the first non-confidential information includes an abstract of the first confidential document or metadata selected from the group including an author of the first confidential document, and an organization associated with the first confidential document.

10. A computer-based apparatus for searching confidential documents, comprising:
at least one memory element of at least one computer configured to store computer readable instructions; and,
at least one processor for the at least one computer configured to execute the computer readable instructions to:
receive from a first source entity:
a first confidential document; and,
first non-confidential information for the first confidential document;
store the first confidential document and the first non-confidential information in the at least one memory element;
restrict access to the first confidential document stored in the at least one memory element to:
the first source entity and a library entity only; or,
the first source entity only;
receive a second confidential document from a second source entity, different from the library entity;
store the second confidential document in the at least one memory element;
perform keyword or semantic analysis to create at least one first index parameter related to content of the second confidential document;
store the at least one first index parameter in the at least one memory element;
identify the at least one first index parameter as being applicable to the first confidential document;
transmit, for access by the second source entity, the first non-confidential information; and,
delete the index parameter and the second confidential document from the at least one memory element.

11. The computer-based apparatus of claim 10, wherein transmitting, for access by the second source entity, the first non-confidential information includes transmitting the first non-confidential information for publically accessible display.

12. The computer-based apparatus of claim 10, wherein the at least one processor for the at least one computer configured to execute the computer readable instructions to:
receive second non-confidential information for the second confidential document from the second source entity; and,
limit access to the second confidential document stored in the at least one memory element to:
the second source entity and the library entity only; or,
the second source entity only.

13. The computer-based apparatus of claim 10, wherein:
the processor is configured to execute the computer readable instructions to:
perform keyword or semantic analysis to create at least one second index parameter related to content of the first confidential document;
store the at least one second index parameter in an index;
receive a search request from a searching entity including a first search parameter;
identify the first search parameter as being applicable to the first confidential document by searching the index to match the first search parameter with the at least one second index parameter; and,
transmit for access by the searching entity, the first non-confidential information.

14. The computer-based apparatus of claim 13, wherein the processor is configured to execute the computer readable instructions to:
delete the first confidential document from the at least one memory element; or,
delete the first confidential document from the at least one memory element and the at least one index parameter from the index.

15. The computer-based apparatus of claim 10, wherein:
the processor is configured to execute the computer readable instructions to:
receive from a third source entity, different from the library entity:
a third confidential document; and,
third non-confidential information regarding the third confidential document;
store the third confidential document and the third non-confidential information in the in at least one memory element;
limit access to the third confidential document stored in the at least one memory element to:
the third source entity and the library entity only; or,
the third source entity only;
perform keyword or semantic analysis of the first and third confidential documents to create at least one second index parameter related to content of the first and third confidential documents;
store the at least one second index parameter in an index;
receive a search request from a searching entity including a first search parameter;
identify the first search parameter as being applicable to the third confidential document by searching the index to match the first search parameter with the at least one second index parameter; and,
transmit for access by the searching entity, the third non-confidential information.

16. The computer-based apparatus of claim 10, wherein the at least one processor is configured to execute the computer readable instructions to:
receive, from the first source entity, a plurality of first confidential documents and a plurality of respective first non-confidential information for the plurality of first confidential documents;
store the plurality of first confidential documents and the plurality of respective first non-confidential information in the at least one memory element;
limit access to the plurality of first confidential documents stored in the at least one memory element to:
the first source entity and the library entity only; or,
the first source entity only;
in response to receiving the search request, rank, in a first order, the plurality of first confidential documents according to relevance with respect to the first search parameter; and,
transmit for access by the searching entity, the plurality of respective first non-confidential information ranked in the first order.

17. The computer-based apparatus of claim 10, wherein the at least one processor for the at least one computer configured to execute the computer readable instructions to:
receive from a third source entity, different from the library entity:
a third confidential document; and,
third non-confidential information regarding the third confidential document;
store the third confidential document and the third non-confidential information in the in at least one memory element;
limit access to the third confidential document stored in the at least one memory element to:
the third source entity and the library entity only; or,
the third source entity only;
receive a search request from a searching entity including a first search parameter;
in response to receiving the search request, ranking, in a first order, the first and third confidential documents according to relevance with respect to the first search parameter; and,
transmit for access by the searching entity, the first and third non-confidential information ranked in the first order.

18. The computer-based apparatus of claim 10, wherein the first non-confidential information includes an abstract of the first confidential document or metadata selected from the group including an author of the first confidential document, an organization associated with the first confidential document, and contact information for the author or the organization.

19. A computer-based method for searching confidential documents, comprising:
storing, in at least one memory element of at least one computer, computer readable instructions; and,
executing, using at least one processor for the at least one computer, the computer readable instructions to:
receive from first and second source entities:
first and second confidential documents, respectively; and,
first and second non-confidential information for the first and second confidential documents, respectively;
store the first and second confidential documents and the first and second non-confidential information in the at least one memory element;
block access to the first confidential document stored in the at least one memory element to all but the first source entity and a library entity, the library entity other than the first source entity;
block access to the second confidential document stored in the at least one memory element to all but the second source entity and the library entity;
perform keyword and semantic analysis of the first and second confidential documents to create at least one first index parameter related to content of the first and second confidential documents;
store the at least one first index parameter in an index;
delete the first and second confidential documents from the at least one memory element;
receive a search request from a searching entity including a first search parameter;
identify the first search parameter as being applicable to the first and second confidential documents by searching the index to match the first search parameter with the at least one index parameter;
rank the first and second confidential documents, according to relevance with respect to the first search parameter, in a first order; and,
transmit for access by the searching entity, the first and second non-confidential information ranked in the first order.

20. A computer-based apparatus for searching confidential documents, comprising:
at least one memory element of at least one computer configured to store computer readable instructions; and,
at least one processor for the at least one computer configured to execute the computer readable instructions to:
receive from first and second source entities:
first and second confidential documents, respectively; and,
first and second non-confidential information for the first and second confidential documents, respectively;
store the first and second confidential documents and the first and second non-confidential information in the at least one memory element;
block access to the first confidential document stored in the at least one memory element to all except the first source entity;
block access to the second confidential document stored in the at least one memory element to all except the second source entity;
perform keyword and semantic analysis of the first and second confidential documents to create at least one first index parameter related to content of the first and second confidential documents;
store the at least one first index parameter in an index;
receive a search request from a searching entity including a first search parameter;
identify the first search parameter as being applicable to the first and second confidential documents by searching the index to match the first search parameter with the at least one index parameter;
rank the first and second confidential documents, according to relevance with respect to the first search parameter, in a first order; and,
transmit for access by the searching entity, the first and second non-confidential information ranked in the first order.
